(19) United States
(12) Patent Application Publication
(10) Pub. No.: US 2023/0157298 A1
(43) Pub. Date: May 25, 2023

(54) COMPOSITION FOR CONTROL OF PESTS AND METHOD OF USE THEREOF

(71) Applicants: Jörg NASS, Goch (DE); Fatih GÜNDÜZ, Gelsenkirchen (DE)

(72) Inventors: Joerg NASS, Goch (DE); Fatih GUENDUEZ, Gelsenkirchen (DE)

(21) Appl. No.: 17/916,864

(22) PCT Filed: Apr. 12, 2021
(86) PCT No.: PCT/EP2021/059372

§ 371 Date: Oct. 4, 2022

(30) Foreign Application Priority Data
Apr. 15, 2020 (DE) 10 2020 110 265.8

(51) Int. Cl. A01N 59/16; A01N 25/10; A01P 7/00

(52) U.S. Cl. CPC A01N 59/16; A01N 25/10; A01P 7/00

(57) ABSTRACT

A composition for control of pests contains zinc oxide which is in the form of tetrapodal crystals, polyvinylpyrrolidone in the following amounts: zinc oxide: 0.5-5 wt %, polyvinylpyrrolidone: 40-65 wt %, water: balance.

### CROSS REFERENCE TO RELATED APPLICATIONS

This application is the National Stage of PCT/EP2021/059372 filed on Apr. 12, 2021, which claims priority under 35 U.S.C. § 119 of German Application No. 10 2020 110 265.8 filed on Apr. 15, 2020, the disclosure of which is incorporated by reference. The international application under PCT article 21(2) was not published in English.

### BACKGROUND OF THE INVENTION

### 1. Field of the Invention

The invention relates to a pest control agent and to a method for its use.

### 2. Description of the Related Art

Termites cause damage worldwide, on the scale of many billions of euros per year.

They destroy crossbeams, studs and rafters, since they feed on their wooden components. Reportedly sugarcane, tea and coffee plantations as well as banknotes and court documents have already been infested by them.

The list of possible counteragents is long. The most common are insecticides and poisonous bait. If the infestation by drywood termites is narrowly limited locally, the insects may also be controlled with hot air or with liquid nitrogen, which is almost as cold as minus 200 degrees Celsius. However, the infested rooms must usually be cleared out for this purpose. Many professional companies also use microwave technology or electrical shock for heating. To combat termites in untreated wood, an agent that paralyzes digestive enzymes is additionally available. The insects then die with a full stomach.

Most control agents are based on chemical substances, such as, for example, insecticides, herbicides or fungicides.

### PRIOR ART

The use of zinc oxide, which exists in the form of tetrapod-shaped crystals, is described, for example, in EP 2 782 103 A1, albeit for lacquered wire, and in DE 10 2013 104 195 A1 for optoelectronic devices.

From CN 101 302 710 A, an agent is known that contains zinc oxide, which exists in the form of tetrapod-shaped crystals, polyvinylpyrrolidone and water.

Investigations on the use of zinc oxide crystals of nanometer size for control of termites are described in
CLAUSEN, C. A. [et al.]: The role of particle size of particulate nano-zinc oxide wood preservatives on termite mortality and leach resistance. In: Nanoscale Res. Lett. Vol. 6, 2011, No. 427.—ISSN 1556-276X
LYKIDIS, C. [et al.]: Termite resistance of beech wood treated with zinc oxide and zinc borate nanocompounds. In: Wood Mater. Sci. Eng., Vol. 13, 2018, No. 1 pp. 45-49.—ISSN 1748-0272
MANTANIS, G.; TERZI, E.; KARTAL, S. N.; PAPADOPOULOS, A. N.: Evaluation of mold, decay and termite resistance of pine wood treated with zinc- and copper-based nanocompounds. In: Int. Biodeter. Biodegr. Vol. 90, 2014, pp. 140-144.—ISSN 0964-8305.

### SUMMARY OF THE INVENTION

Task of the invention: The above-mentioned disadvantages of the prior art are to be avoided; in particular, the pest control agent is to act effectively in purely mechanical manner, i.e. without chemical poisons.

This task is accomplished according to the invention by the pest control agent, wherein the agent contains zinc oxide, which exists in the form of tetrapod-shaped crystals, polyvinylpyrrolidone and water and is characterized by the following composition:
zinc oxide: 0.5-5 wt %
polyvinylpyrrolidone: 40-65 wt %
water: the rest.

### Advantages of the Invention

The following advantages among others are achieved:

The agent is a purely mechanical defense against pests. It consists of an aqueous polyvinylpyrrolidone solution (PVP), e.g. “Luvitec® K 90 solution 20%” of BASF, and zinc oxide, which exists in the form of powder-like tetrapod crystals. These zinc oxide tetrapod crystals are some nanometers in size (nano zinc oxide tetrapods/NZT). The agent is manufactured in a condition ready-mixed for application. The ready-mixed agent is usable, including PVP carrier material.

Depending on requirement, this free-flowing agent may also contain still other substances. Thereby the agent may have a different viscosity and in particular may also be adherent.

Due to the special tetrapod shape as illustrated in FIG. 1, the various pests are killed either while feeding or by the mere contact with the nanoparticles.

Such death occurs purely mechanically and without any environmental pollution.

Advantageous configurations of the invention are listed in the dependent claims.

The following are proposed:
that the diameter of the circumscribed sphere of the tetrapod-shaped zinc oxide crystals be between 1 and 100 nanometers in size,
that the agent contain a natural and/or a synthetic resin.

The agent acts in such a way that the nano zinc oxide tetrapod particles are absorbed in high concentration in the digestive organs of the pests, where they lead to metabolic failure.

A specific property of the nano zinc oxide tetrapods is in particular their shape (see FIG. 1).

This leads upon external contact to microscopically small injuries between joints and in openly exposed mucous membranes. Due to the tetrapod shape of the nanoparticles, it is no longer possible to remove them. Any attempt to release them causes deeper penetration of the tetrapods instead.

Thus absorption in the organism also leads to far-reaching damage.

If nano zinc oxide tetrapods are mixed exclusively with water, the tetrapods clump together and are unfit for the planned use. In order to achieve the desired effect, a suitable carrier material must therefore be found in order to bring the tetrapods specifically and without short-term loss onto or into the point of use.

Polyvinylpyrrolidone (PVP) is used as carrier material. PVP is a largely safe substance and may also be absorbed by organisms.

The zinc oxide tetrapods have a size of 1 to 100 nanometers.

For the preparation of 100 mL of the agent, it is possible, for example, to stir 60 mL of polyvinylpyrrolidone “Luvitec® K 90 solution 20%” (trade name of BASF SE), 35 mL of water and 5 g of nano zinc oxide tetrapods of Tianjin Y R Chemspec Co., Ltd. by means of a dispersion stirrer at low to medium speed for approximately 1 to 3 minutes.

Optionally, the agent may also be mixed with one or more resins during preparation. This is likewise carried out by means of a dispersion stirrer. In the process, the original agent adheres temporarily to the resin or resins. In this way, the agent may be applied in weatherproof and adhering condition onto a vertical object (such as a tree).

Such a resin may consist of natural resin and/or synthetic resin. For the tests, the natural resin oil “MELDOS Natur-Hartöl No. 265” (trade name of Livos Pflanzenchemie-, Forschungs- and Entwicklungsgesellschaft mbH & Co. Kommanditgesellschaft) was used as a natural resin and the polyester resin “presto Polyesterharz” (trade name of MOTIP DUPLI GmbH) was used as a synthetic resin. Epoxy resin or acrylic resin may also be used as the synthetic resin.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows the zinc oxide tetrapods in an electron microscope photograph.

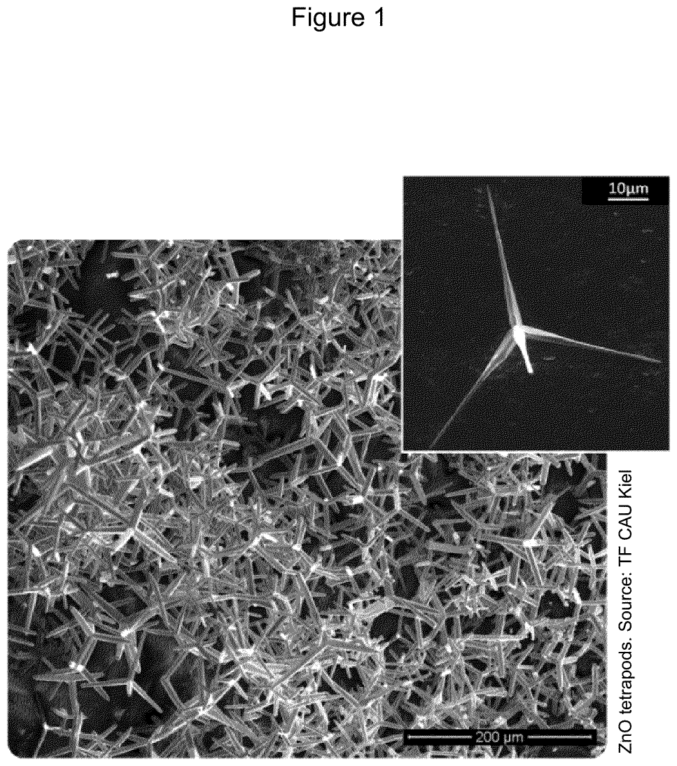

### Example 1: Termite Control for Residential Buildings

The wood construction widely used for the carcass structure of buildings in the countries of North America, for example, leads annually to considerable and expensive damage.

In this example, the agent contains resin. The construction woods used are coated over their full surface with the agent prior to their assembly.

The coating may be applied in the pressure-injection method or manually with a painting implement.

The construction woods may be installed after a drying time of 2 to 4 hours.

The agent may also be applied subsequently on already built-in materials.

The agent may also be combined with conventional wood preservatives; where it is also necessary, the woods may be protected from moisture penetration.

In this example, the agent is usually colorless and has low viscosity.

During processing, the usual industrial safety measures are to be respected.

For an average building of the size of a single-family dwelling of wood construction, approximately 40 m³ of wood is processed. This coating would require approximately 100 liters of the agent.

After the treatment, the woods are protected from being eaten by termites.

### Example 2: Defense Against Bark Beetles and Control of Caterpillars or Snails

In spruce forests, increasing havoc is being wreaked due to feeding by bark beetles. The culprit is above all the eight-toothed European spruce bark beetle; since the drought of 2003, the much smaller six-toothed spruce bark beetle has also contributed substantially to the death of larger stands of spruce trees. The eight-toothed European spruce bark beetle is the most dangerous bark beetle and forest pest in temperate latitudes. The starting points for mass reproduction are calamities such as windstorms, snow breakage or drought.

For mechanical defense, ring traps are now being attached. A ring trap is a circular container that surrounds an object. The filler, which is introduced into the trap, may be a liquid or a dry powder.

The agent is mixed with an insect food and the ring trap is then loaded with it.

The ring trap forms a barrier that the walking insects must cross to continue on their way. While crossing the trap, they become wetted with the agent.

It is also even possible to mix the liquid agent additionally with a natural or synthetic resin and then to use it. For the application to vertical objects, a part of the finished agent is mixed with three parts of natural or synthetic resin and filled into a container.

Instead of using a ring trap, it is possible to combine the agent shortly before use with a natural or synthetic resin and then to spray or paint it over the entire surface of a tree trunk to be protected.

The finished agent bonds only temporarily with natural or synthetic resins. These are used to apply the agent in weatherproof and adhering condition on a vertical object (such as a tree).

Since small nano zinc oxide tetrapods are now present on the surface of the tree bark, forming blade-like patterns with four blade-like legs, the tree pests (bark beetles) are killed while trying to bore into the bark in order to lay eggs there.

### Example 3

The agent, which in this case contains no natural or synthetic resin, contains PVP in order to bond the zinc oxide tetrapods. In water, the zinc oxide tetrapods would clump together without addition of PVP. PVP is a largely safe substance and may be absorbed by organisms.

The agent was mixed into a sugar solution, which was then presented to an ant group of 15 to 20 insects, for which any liquid intake had been made impossible for two days long beforehand in a sterile environment.

After 24 hours, a distinct decline in movement was apparent.

After 48 hours, the group was almost completely immobile, even relative to external stimulus.

The death occurred after 60 to 84 hours.

The same series of tests was likewise carried out on a termite group of 15 to 20 insects after 2 days of liquid deprivation. The results were almost identical.

### Example 4

An untreated cube of spruce wood measuring 50 mm×50 mm was placed in a container of a termite group after three days of isolation. As expected, the insects began to process the wooden cube with their biting apparatus.

The test was repeated, but this time the cube of spruce wood was coated with the agent, which contained no resin. Here also, the termites began to process the wooden cube. After 24 hours, the intensity of the processing decreased significantly. After a further 12 hours, the cube was no longer being attacked.

Similar results were achieved respectively when the agent was mixed with natural or synthetic resin and the wooden cube was then coated with the agent.

### Example 5

A bark beetle group received exclusively spruce and fir wood as food in an isolated environment. After three weeks, there was no change of the population.

In this example, the agent contains natural and synthetic resin. A comparison group likewise consisting of bark beetles likewise received spruce and fir wood as food, but this time it had been coated respectively with the agent. Individual insects were dead after 1-2 weeks and the entire group was dead after three weeks.

It is to be assumed that similar effects will also be found for other pests, such as, for example, snails, oak processionary moths, etc.

### Further Advantages

Further advantages of pest control with the agent are even longer control intervals, which may be limited to as few as one application per year.

A further advantage is the long durability of the applied agent. The agent is not rapidly flushed into the soil by wet weather.

In the case of use in the dry indoors area, a single application is sufficient for decades. A follow-up pest control is no longer necessary.

1. A pest control agent,
comprising the following composition in the following amounts:
zinc oxide: 0.5-5 wt %;
polyvinylpyrrolidone: 40-65 wt %;
water: the rest;
wherein zinc oxide exists in the form of tetrapod-shaped crystals.

2. The pest control agent according to claim 1 for control of bark beetles, snails, termites, oak processionary moths and ants.

3. The pest control agent according to claim 1, wherein a diameter of a circumscribed sphere of the tetrapod-shaped zinc oxide crystals is between 1 and 100 nanometers in size.

4. The pest control agent according to claim 1, wherein the agent contains a natural and/or a synthetic resin.

5. A method for killing of ants and termites, comprising mixing the pest control agent according to claim 1 into a sugar solution and then, in a vicinity of the ants or termites, providing the sugar solution and pest control agent mixture to the ants or termites.

6. A method for protection of trees and of wood from termites and bark beetles, comprising coating the trees or woods with the pest control agent according to claim 1.

7. The method according to claim 6, wherein the agent is mixed with natural or synthetic resin shortly before application.

8. The method according to claim 6, wherein the trees or woods comprise spruce and fir.
